(19) United States
(12) Patent Application Publication
(10) Pub. No.: US 2009/0146811 A1
(43) Pub. Date: Jun. 11, 2009

(54) METHOD AND APPARATUS FOR PREVENTING WATER DAMAGE TO ARTICLES

(76) Inventors: Peter W. Burka, Ottawa (CA); Karl M. Taylor, Kanata (CA)

Correspondence Address: HOFFMAN WARNICK LLC, 75 STATE ST, 14TH FLOOR, ALBANY, NY, 12207, US

(21) Appl. No.: 11/954,025

(22) Filed: Dec. 11, 2007

(51) Int. Cl. G08B 13/14

(52) U.S. Cl. 340/572.1

(57) ABSTRACT

The present invention is directed to a method and apparatus for preventing water damage to non-washable articles in a washing machine. A method in accordance with an embodiment of the present invention includes: providing an article with a radio frequency identification (RFID) tag identifying the article as being non-washable; preventing the article from being washed in a washing machine by: scanning the washing machine using an RFID reader; and generating an alarm upon detection of a predetermined code emitted by the RFID tag.

### BACKGROUND OF THE INVENTION

1. Field of the Invention

The present invention generally relates to preventing water damage. More specifically, the present invention is directed to a method and apparatus for preventing water damage to non-washable articles in a washing machine.

2. Related Art

Many people have inadvertently damaged or destroyed valuable electronics or expensive clothing by unintentionally washing these items in a domestic clothes washer. Personal Digital Assistants (PDAs) and digital cameras do not respond well to soap, water, and agitation. Nor do various materials such as leather, fur, or certain textiles, which must only be dry-cleaned. To avoid such damage, the owner must carefully examine the washing instruction tags attached to non-washable items, and search all pockets for electronics and other non-washable items. This process is error prone, and a single mistake can prove very expensive.

### SUMMARY OF THE INVENTION

The present invention is directed to a method and apparatus for preventing water damage to non-washable articles in a washing machine. A non-washable article is provided with a radio frequency identification (RFID) tag. The RFID tag is configured to emit a predetermined code, indicating that the article to which the RFID tag is associated with (e.g., attached to) is “non-washable,” when scanned by an RFID reader associated with the washing machine. The RFID reader detects the presence of the non-washable article via the predetermined code (e.g., prior to a wash cycle) and alerts the user. The user can then remove the non-washable article from the washing machine.

A first aspect of the invention is directed to a washing system, comprising: an article; a radio frequency identification (RFID) tag associated with the article and identifying the article as being non-washable; a washing machine; and an RFID reader associated with the washing machine for detecting the RFID tag.

A second aspect of the present invention is directed to a method, comprising: providing an article with a radio frequency identification (RFID) tag identifying the article as being non-washable; preventing the article from being washed in a washing machine by: scanning the washing machine using an RFID reader; and generating an alarm upon detection of a predetermined code emitted by the RFID tag.

A third aspect of the present invention is directed to a method for preventing washing of a non-washable article, comprising: providing the non-washable article with a radio frequency identification (RFID) tag; scanning a washing machine using an RFID reader to detect the RFID tag; and generating an alarm upon detection of the RFID tag.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative system in accordance with an embodiment of the present invention.

FIG. 2 depicts an illustrative system in accordance with another embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As described above, the present invention is directed to a method and apparatus for preventing water damage to non-washable articles in a washing machine. Each non-washable article is provided with a radio frequency identification (RFID) tag. The RFID tag is configured to emit a predetermined code, indicating that the article to which the RFID tag is associated with (e.g., attached to) is “non-washable,” when scanned by an RFID reader associated with the washing machine. The RFID reader detects the presence of the non-washable article via the predetermined code (e.g., prior to a wash cycle) and alerts the user. The user can then remove the non-washable article from the washing machine.

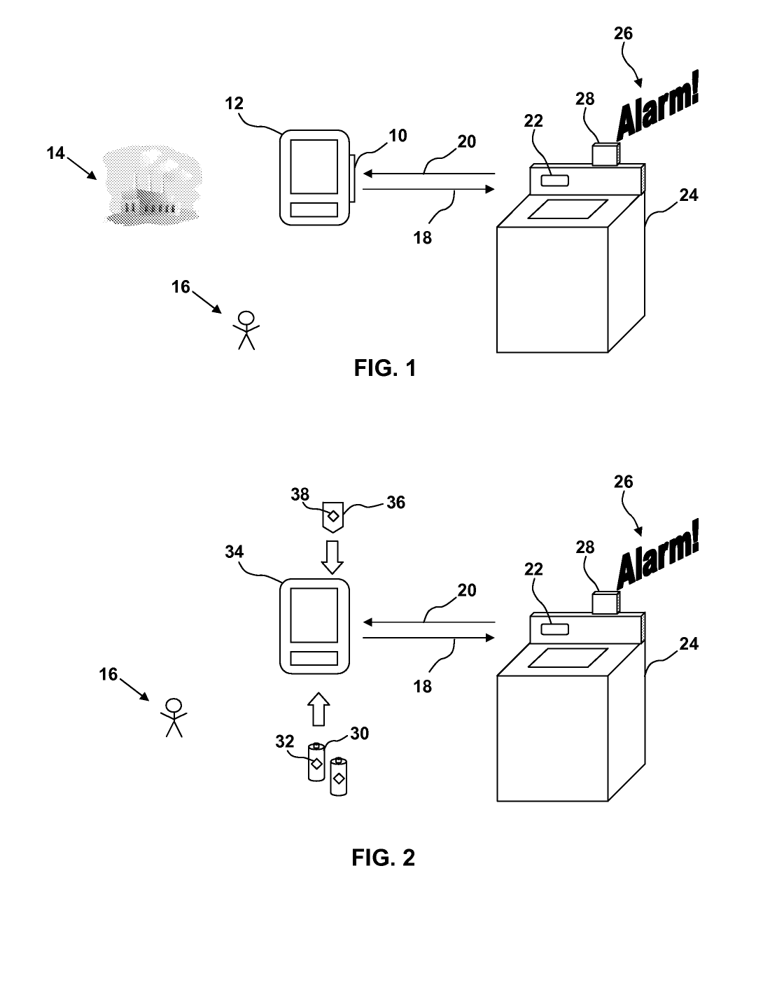

As depicted in FIG. 1, in accordance with an embodiment of the present invention, an RFID tag 10 is attached to, or otherwise associated with, a non-washable article 12, which in this example comprises a personal digital assistant (PDA). It should be noted, however, that the non-washable article 12 can comprise any type of article that should not be placed in a washing machine. This can include, for example, articles that would be damaged or ruined if washed (e.g., electronic devices, dry clean only clothes), articles that can damage or ruin other articles that are being washed (e.g., a pen, a darkly dyed article of clothing), and/or the like. The RFID tag 10 can be attached to, and/or installed in, the non-washable article 12 in any suitable manner/location. For example, a manufacturer 14 or user 16 of the non-washable article 12 can attach the RFID tag 10 to the exterior or interior of the non-washable article 12. One suitable location could be the inside of the cover to the battery compartment of the non-washable article 12, assuming the non-washable item 12 is battery powered.

The RFID tag 10 is configured to operate in a conventional manner by emitting a predetermined code 18, in this case indicative of a non-washable status, when scanned 20 by an RFID reader 22. The RFID reader 22 can be built into a washing machine 24, can be attached/retrofitted to the washing machine 24, and/or can be provided as a separate unit disposed in the vicinity of the washing machine 24. In the case of multiple non-washable articles 12, each non-washable article 12 can emit the same or a different predetermined code 18 indicative of a non-washable status. If different predetermined codes 18 are used for each non-washable article 12, the RFID reader 22 can be configured to recognize each different predetermined code 18.

The RFID 22 reader recognizes the predetermined code 18 indicative of the non-washable status of the non-washable article 12. In an embodiment, the RFID reader 22 can be configured to scan the contents of the washing machine 24 (e.g., in the drum of the washing machine 24) at the onset of a washing cycle. If, in response to the scan, the RFID reader 22 receives the predetermined code 18, indicating that the non-washable article 12 is in the washing machine 24, the RFID reader 22 warns the user 16 by initiating an alarm 26 via an alarm system 28. Any suitable alarm 26, such as a visual alarm (e.g., flashing red light), an audible alarm (e.g., a loud beeping sound, klaxon), and/or the like can be employed. In another embodiment, the RFID reader 22 can provide a “shut-down” signal to the washing machine 24, which prevents the washing cycle from commencing/continuing until the non-washable article 12 is removed from the washing machine 24. In response to the alarm 26, the user 16 can remove the non-washable article 12 from the washing machine 24 and restart the washing cycle. The alarm 26 can be deactivated by the user 16 and/or can be automatically terminated by the RFID reader 22 after the non-washable article 12 has been removed from the washing machine 24 and is no longer detected by the RFID reader 22.

In another embodiment, the RFID reader 22 can be configured to periodically/continuously scan the contents (e.g., a load of laundry) of the washing machine 24 and/or the immediate vicinity of the washing machine 24 (e.g., the contents of a laundry basket near the washing machine 24, a pile of laundry placed on the top of the washing machine 24 or nearby dryer, etc.). If, in response to the scan(s), the RFID reader 22 receives the predetermined code 18, indicating that the non-washable article 12 is in/near the washing machine 24, the RFID reader 22 warns the user 16 by initiating an alarm 26 via an alarm system 28. In this way, the RFID reader 22 preemptively warns the user 16 that the non-washable article 12 is in a “washing” location.

In another embodiment, RFID tags are attached to batteries for use in consumer electronics (e.g., digital audio players, PDAs, cellular telephones, etc.). As depicted in FIG. 2, for example, the user 16 can install batteries 30 that include RFID tags 32 in a battery-powered, non-washable article 34. The RFID tag 32 can, for example, be affixed to an outside surface of a battery 30. This saves the user 16 from having to modify the non-washable article 34 itself (e.g., by installing an RFID tag internally) or disfiguring the non-washable article 34 (e.g., by affixing an RFID tag externally). Similarly, a memory card 36 for storing data associated with (e.g., used by, generated by, etc.) the non-washable article 34 can include an RFID tag 38. This protects not only the non-washable article 34, but also the memory card 36 itself. The RFID tag 38 can, for example, be affixed to an outside surface of a memory card 36 or can be incorporated within the housing of the memory card 36. In both of these embodiments, the RFID tags 32, 38 operate similarly to the RFID tag 10 detailed above. To this extent, the RFID tags 32, 38 are configured to emit a predetermined code 18, indicative of a non-washable status, when scanned 20 by an RFID reader 22 associated with a washing machine 24. If, in response to the scan, the RFID reader 22 receives the predetermined code 18, indicating that the non-washable article 34 is in/near the washing machine 24, the RFID reader 22 warns the user 16 by initiating an alarm 26 via the alarm system 28.

The present invention can also be applied to articles which can damage other articles if washed together in a washing machine. For example, the article can comprise a pen, which if washed, could lead to the staining of the other articles in the washing machine. To this extent, an RFID tag can be attached to the pen or other potentially damaging article. Thus, the phrase “non-washable” encompasses not only articles that can be damaged when washed, but also articles that, if washed, could damage other articles being washed.

The foregoing description of the embodiments of this invention has been presented for purposes of illustration and description. It is not intended to be exhaustive or to limit the invention to the precise form disclosed, and many modifications and variations are possible.

What is claimed is:

1. A washing system, comprising:
an article;
a radio frequency identification (RFID) tag associated with the article and identifying the article as being non-washable;
a washing machine; and
an RFID reader associated with the washing machine for detecting the RFID tag.

2. The washing system of claim 1, wherein the article is non-washable.

3. The washing system of claim 1, further comprising:
an alarm system for generating an alarm upon detection of the RFID tag.

4. The washing system of claim 1, wherein the RFID tag is attached to the article.

5. The washing system of claim 1, further comprising:
a battery for powering the article, wherein the battery includes the RFID tag.

6. The washing system of claim 1, further comprising:
a memory card for storing data associated with the article, wherein the memory card includes the RFID tag.

7. The washing system of claim 1, wherein the RFID reader is:
built into the washing machine;
attached to the washing machine; or
provided as a separate unit disposed in a vicinity of the washing machine.

8. A method, comprising:
providing an article with a radio frequency identification (RFID) tag identifying the article as being non-washable;
preventing the article from being washed in a washing machine by:
scanning the washing machine using an RFID reader; and
generating an alarm upon detection of a predetermined code emitted by the RFID tag.

9. The method of claim 8, further comprising:
attaching the RFID tag to the article.

10. The method of claim 8, further comprising:
powering the article using a battery, wherein the battery includes the RFID tag.

11. The method of claim 8, further comprising:
storing data associated with the article on a memory card, wherein the memory card includes the RFID tag.

12. A method for preventing washing of a non-washable article, comprising:
providing the non-washable article with a radio frequency identification (RFID) tag;
scanning a washing machine using an RFID reader to detect the RFID tag; and
generating an alarm upon detection of the RFID tag.

13. The method of claim 12, further comprising:
preventing operation of the washing machine until the non-washable article is removed from the washing machine.
